(19) United States
(12) Patent Application Publication
(10) Pub. No.: US 2013/0005556 A1
(43) Pub. Date: Jan. 3, 2013

(54) Device and Method for Placing Immiscible Fluid Phases in Contact with Each Other by Means of Centrifugal Force

(75) Inventors: Alain Paul Olivier Foucault, Saint-Nazaire (FR); Jack Legrand, Saint-Nazaire (FR); Luc Marchal, Saint-Nazaire (FR); Charles Elie Pierre Agaise, Nantes (FR)

(73) Assignees: UNIVERSITE DE NANTES, Nantes (FR); CENTRE NATIONAL DE LA RECHERCHE SCIENTIFIQUE, Paris (FR)

(21) Appl. No.: 13/513,013

(22) PCT Filed: Nov. 26, 2010
(86) PCT No.: PCT/IB10/55456

§ 371 Date: Sep. 19, 2012

(30) Foreign Application Priority Data
Dec. 1, 2009 (FR) 09 05784

(51) Int. Cl. B04B 5/06; B01D 17/038

(52) U.S. Cl. 494/22; 494/37

(57) ABSTRACT

The present invention relates to a device and a method for placing immiscible fluid phases in contact with each other by means of centrifugal force, in particular in order to extract compounds from one of said phases by another phase. Said device comprises at least one contacting unit (3*) which is capable of being rotated about an axis (X′X) and which includes a plurality of cells (210, A, D) intended to be passed through consecutively by said phases, in a given flow direction, each cell being provided with two inlet/outlet channels (214 and 215) which fluidly connect the cells together in pairs and which lead into each cell, respectively, via two inlet/outlet openings, which are proximal (214a) and distal (215a) relative to the said axis, respectively. According to the invention, for at least two adjacent cells (A and D) of said at least one unit, the two proximal (214a) or else distal (215a) openings thereof are connected together directly via one of said channels (214 or 215), whereby said phases flow through one of said adjacent cells towards said axis and through the other cell while moving away from said axis.

The present invention relates to a device and a process for bringing immiscible fluid phases into contact by means of centrifugal force, in particular for extracting compounds from one of these phases using another phase. The invention applies in particular, but not exclusively, to liquid-liquid, gas-liquid or solid-liquid-liquid extraction, to chromatographic applications, to chemical reactions in a two-phase medium or else to the production of nanoemulsions.

Known centrifugal liquid-liquid extraction devices may comprise circumferential arrangements of mixing cells and optionally of decantation cells that are rotated, as illustrated for example in document DE-A-31 30 967.

Known centrifugal partition chromatography (CPC) devices, i.e. devices that enable a separation of the compounds of a mixture between a mobile phase and a stationary phase for each of which the compounds have a different affinity, comprise a stack of flat rings which are rotated about their axis of symmetry and which each comprise, in a plane perpendicular to this axis, a multitude of cells connected together by inlet/outlet ducts or channels that are, for example, etched on these rings. The stationary phase is held immobile inside the cells by the centrifugal force to which it is subjected due to the rotation of the rings, whilst the mobile phase percolates this stationary phase via phase circulation means, such as pumps. A radially inward flow (i.e. from the periphery toward the center) of the mobile phase through each cell represents, for the stack of rings, an ascending flow, whereas conversely a radially outward flow (i.e. from the center toward the periphery) represents a descending flow, the direction of the flow being determined by the ratio of the densities of the mobile phase and of the stationary phase. Reference could, for example, be made to documents FR-A-2 791 578 and FR-A-2 923 398 for the description of such devices.

These known devices of the type having phase-contacting cells which are arranged over the circumference of the rotating unit while being connected to one other all have in common the fact of involving, for a given flow direction over this circumference (i.e. in the clockwise or anticlockwise direction), one and the same direction of passing through the cells which is radially outward from each cell (i.e. in a descending direction where the discontinuous heavy phase percolates the continuous light phase) or else radially inward from each cell (i.e. in an ascending direction where the discontinuous light phase percolates the continuous heavy phase).

One objective of the present invention is to propose a novel device for bringing immiscible fluid phases into contact by means of centrifugal force, in particular for extracting compounds from one of these phases using another phase, which makes it possible in particular to optimize the agitation of these phases compared to the aforementioned current centrifugal extraction devices, this device comprising at least one contacting unit which is capable of being rotated about an axis and which comprises a plurality of cells configured to be passed through successively by these phases in one and the same given flow direction, each cell being provided with two inlet/outlet channels which fluidly connect the cells together in pairs and which open into each cell respectively via two inlet/outlet orifices which are respectively proximal and distal with respect to said axis.

For this purpose, a device according to the invention is such that, for at least two adjacent cells of said at least one unit, their two proximal orifices or else their two distal orifices are directly connected together by one of these channels, so that these phases flow through one of these adjacent cells toward said axis and through the other cell away from said axis.

This device of the invention is thus of co-current centrifugal type due to the identical flow direction of the phases from one cell to the next, which phases are at least two in number.

It will be noted that this device, via these two directions (centrifugal and centripetal) for crossing of the cells by the phases which are predetermined by this specific arrangement of their inlet/outlet orifices and which result in at least one inversion of the continuous and discontinuous nature of these phases during their contacting in the cells, makes it possible to significantly improve the efficacy of the mixing of the phases and therefore advantageously that of the desired mass transfer.

According to another feature of the invention, these channels may subdivide into at least one proximal channel formed between said axis and said two adjacent cells which it connects to one another via their respective proximal orifices and/or into at least one distal channel formed beyond said two adjacent cells with respect to said axis which it connects to one another via their respective distal orifices.

Advantageously, said at least one unit may comprise a ring which is capable of being rotated about its axis of symmetry forming said axis and on the circumference of which said plurality of cells is formed. This plurality of cells may have, repeated multiple times over the circumference of said or each ring, on the one hand, said two adjacent cells having radially inner proximal orifices that are connected together and, on the other hand, said two adjacent cells having radially outer distal orifices that are connected together, so that these phases flow through the cells radially toward the inside and toward the outside in a predetermined, preferably alternate sequential manner over this circumference.

It will be noted that the alternation, over the circumference of said at least one unit, of cells having proximal orifices connected together and cells having distal orifices connected together (i.e. “CF” cells that are passed through centrifugally and “CP” cells that are passed through centripetally, which are capable of being passed through by the phases radially toward the outside and toward the inside, respectively, in the sequence . . . CP-CF-CP-CF-CP-CF-CP . . . ), constitutes a preferential embodiment of the invention due to the fact that it rapidly forces, at each crossing of a cell, the aforementioned inversion of the continuous/discontinuous phases, further improving the intensity of the agitation of the phases that is obtained.

As a variant, provision may also be made, due to another arrangement chosen for these orifices and therefore for the inlet/outlet channels of the cells, for these continuous/discontinuous phase inversions to be predetermined by an arrangement that follows a non-alternating pattern that may or may not be repeated over the circumference of said at least one unit, such as for example a sequence of cells . . . CP-CP-CF-CP-CP-CF-CP-CP . . . , . . . CP-CF-CF-CP-CF-CF-CP . . . or any other sequence involving a different number of CP cells between two CF cells and/or a different number of two CF cells between two CP cells.

As a variant of the or each aforementioned ring, it will be noted that said at least one unit could comprise a non-annular (i.e. neither circular, nor cylindrical) support for the cells, such as for example a sector of disc or of cylinder or else a cassette having another geometry.

More advantageously still, the or each ring may comprise several of said proximal channels and several of said distal channels that are respectively radially inner and outer with respect to the cells that they connect together and that both extend substantially perpendicular to the radial direction of this ring passing through said axis.

Preferably, each of the cells has said two inlet/outlet orifices which are respectively radially inner and radially outer with respect to this cell and which are substantially situated on a radial line of said or each ring passing through said axis and for example through the barycenter of this cell seen in radial cross section. As a variant, it will be noted that the inlet/outlet orifices of each cell could be offset with respect to its barycenter.

As regards the geometry of the cells formed in said at least one unit, it may be any geometry in the radial direction of its length, in the tangential direction (perpendicular to this radial direction) of its width and in the axial direction of its thickness. Each cell may for example have, seen in planar cross section perpendicular to said axis of rotation, a polygonal, rounded, oblong or other shape, and this shape may optionally vary from a CF cell that is passed through centrifugally to a CP cell that is passed through centripetally.

According to one embodiment of the invention, each of the cells may be formed of several compartments which are juxtaposed in the radial direction by being connected together in pairs via a radial fluid bridge. These compartments of one and the same cell, which may be identical or different, each have for example an oblong shape in the circumferential direction, the or each radial bridge being substantially aligned with said two inlet/outlet orifices of each cell.

According to another feature of the invention, said device may comprise a multitude of said rings of flat shape which are stacked about said axis and which are configured to form as many stages of mass transfer, via a gravitational field to which the cells are subjected and which matches descending and ascending movements of the phases respectively to their radially outward and inward flow through the cells.

According to another feature of the invention, said device may be provided with means for collecting said phases that are formed:
at the outlet of the device in the form of a separate decanter, or else,
by a disc rotating about said axis that is integrated into the device at the outlet of said unit(s), via a decantation channel formed in this disc in a substantially circular manner along a constant or variable width or else in a spiral.

A process for bringing immiscible fluid phases into contact by means of centrifugal force according to the invention, in particular for extracting compounds from one of these phases using another phase, this process comprising a rotation about an axis of a plurality of contacting cells which are passed through successively by these phases in order to obtain in each cell a continuous phase in which another discontinuous phase is dispersed, is such that it comprises a flow in one and the same given direction of the phases from cell to cell so that these phases come closer to then move away from said axis when they pass through these cells, in order to obtain an inversion of the continuous phase and of the discontinuous phase at each change of their direction for passing through the or each corresponding cell.

According to another feature of the invention, by means of this process one of the phases, or heavy phase, is dispersed in the other phase, or light phase, at the or each phase inversion resulting from them passing through a “CF” cell in the centrifugal direction of moving away from said axis and, conversely, the light phase is dispersed in the heavy phase at the or each phase inversion resulting from them passing through a “CP” cell in the centripetal direction of moving closer to said axis. It will be noted that one or more other intermediate phases can optionally be used in this process, in addition to these light and heavy phases.

According to another preferential feature of the invention, multiple inversions of these continuous and discontinuous phases are performed in a predetermined and preferably alternate sequential manner at each change of their direction for passing through the cells.

Advantageously, the cells can be formed in at least one contacting unit that is rotated about its axis of symmetry forming said axis and over the circumference of which said plurality of cells is formed, which cells generate these multiple inversions of continuous and discontinuous phases via the arrangement of inlet/outlet channels connecting these cells together in pairs.

According to one exemplary embodiment of the invention advantageously relating to the case where the flow rate of the heavy phase is greater than that of the light phase, the cells have at least two different widths in the circumferential direction, including a minimum cell width and a maximum cell width for the “CP” and “CF” cells passed through by these phases radially inward and outward, respectively.

According to another preferential feature of the invention, these phases are brought into contact via a gravitational field to which the cells are subjected and which matches descending and ascending movements of the phases respectively to them passing through the cells radially outward and inward.

According to another aspect of the invention, an operation is performed via this contacting step, which operation may be chosen from the group consisting of liquid-liquid extractions, gas-liquid extractions, solid-liquid-liquid three-phase extractions, chromatographies, chemical reactions in a two-phase medium and the production of nanoemulsions, and optionally, in addition, a decantation operation is carried out in order to separate the phases brought into contact in said cells from one another.

Regarding the three-phase solid-liquid-liquid extraction devices, the solid phase may be in the form of a suspension in one or in both of the liquid phases.

Regarding the liquid-liquid chromatography (“CPC”) devices, it will be noted that it is possible to play with the sizing of the “CP” cells that are passed through centripetally and the “CF” cells that are passed through centrifugally and with the flow rates of the two fluids so that their respective residence times are very different from one another. Solutes may then be separated between the shortest time and the longest time, and the injections may be repeated as many times as necessary.

Regarding the devices of chemical reactor type, it is possible to envisage, for example, the presence in the light phase of a catalyst that is insoluble in the heavy phase, and the presence in the heavy phase that is incorporated into the device of two molecules M1 and M2 which, in contact with this catalyst (i.e. at the interface between the two phases), react to give a molecule M3, itself in the heavy phase. The intense agitation of the two phases within the device favors the kinetics of the chemical reaction, and the light phase containing the catalyst is recycled at the outlet of this device.

Regarding the production of nanoemulsions, it is possible, owing to the device and to the process of the invention, to obtain micelles, liposomes and other nanoscale articles of this type by phase inversion that is controlled and repeated several times without resorting, as in the prior art, to a temperature change, but solely by controlling the hydrodynamics of the fluids via the flow rates and the crossing of the cells in the two centrifugal and centripetal directions.

It will generally be noted that the device and the process of the invention which carry out these continuous/discontinuous phase inversions in a controlled manner make it possible to precisely control the two-phase flows in the cells, via a set of parameters such as the rotational speed of said at least one unit and the overall flow rate, and to thus give rise to an intense agitation of the phases. It results from this intensification of the unitary operation implemented by the invention that the volume of the contactor formed by this device may be significantly reduced, which makes it possible to reduce the cost of this unitary operation.

The control of the flow rates of the phases also makes it possible to reduce the consumption of organic solvents while increasing the efficiency of the unit. The device according to the invention may further enable the use of solvents that hitherto could not be used with conventional extractors, especially “green” solvents.

This optimized control according to the invention of the two-phase aqueous systems may be for example used in the field of the extraction of biological substances, such as proteins, viruses, etc.

In hydrometallurgy, the extraction of metals by the customary complexing agents and their re-extraction may be improved owing to the increase of the kinetics of the steps which is due to the optimized agitation provided by the multiple phase inversion according to the invention.

The intensification of the unitary operations obtained by the device and the process of the invention find significant applications in the nuclear industry, in fine chemistry, in the pharmaceutical and cosmetic industries and in the agri-food industries.

The aforementioned features of the present invention, and others too, will be better understood on reading the following description of several exemplary embodiments of the invention, given by way of illustration and non-limitingly, the description being given in relation to the appended drawings, among which:

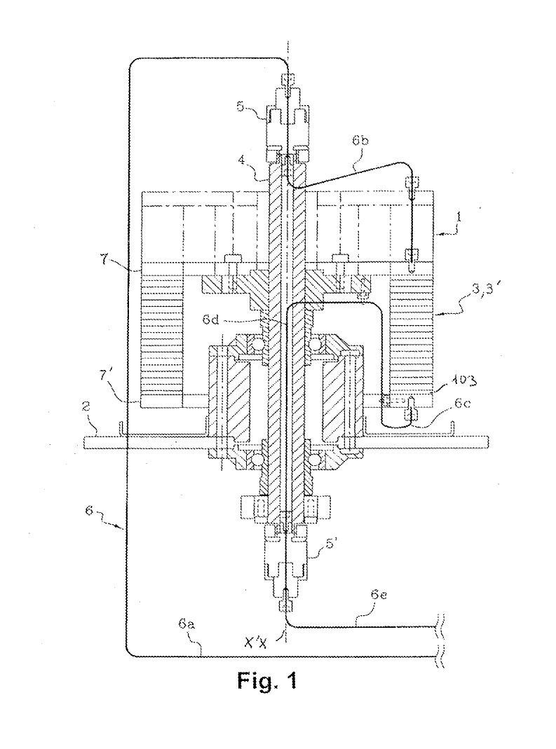

FIG. 1 is a schematic axial cross-sectional view in a vertical plane of a centrifugal device according to the invention of the type having stacked rings according to one preferential embodiment of the invention,

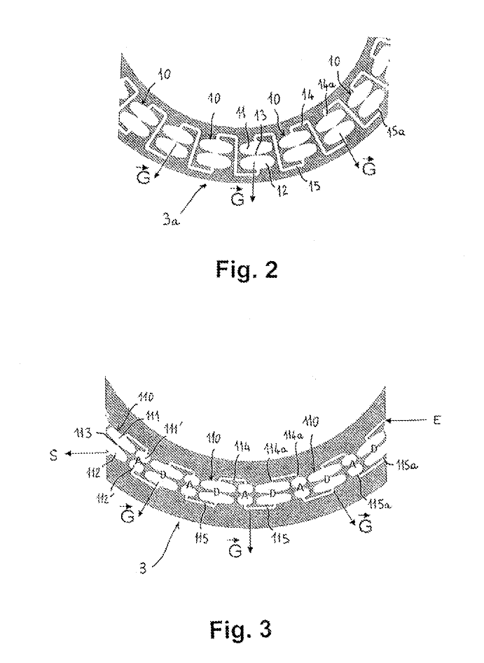

FIG. 2 is a schematic partial top view of such a ring not in accordance with the invention which is intended for centrifugal partition chromatography and the cells of which are connected according to the prior art,

FIG. 3 is a schematic partial top view of a ring according to the invention that can be used in the device from FIG. 1, the cells of which that are passed through centrifugally and centripetally are arranged alternately according to a preferential exemplary embodiment of the invention,

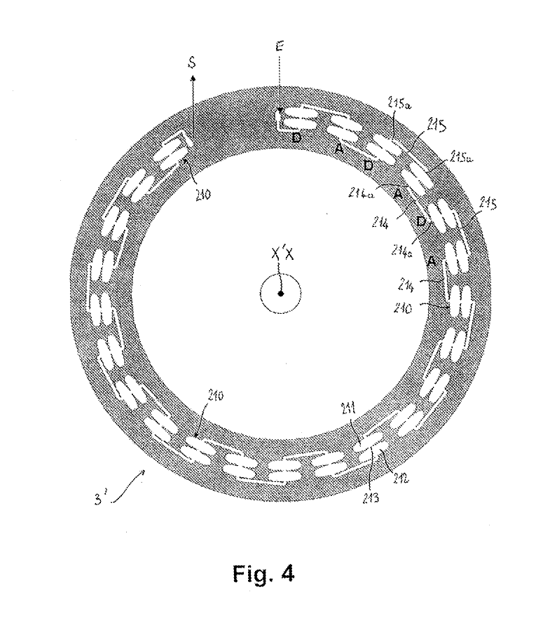

FIG. 4 is a schematic top view of the whole of a ring according to the invention, the cells of which that are passed through centrifugally and centripetally are alternated but correspond to a variant of FIG. 3,

FIG. 5 is a photograph showing, as a top view, three cells of a ring according to FIG. 4 being passed through by two liquid phases respectively constituted of ethyl acetate and water,

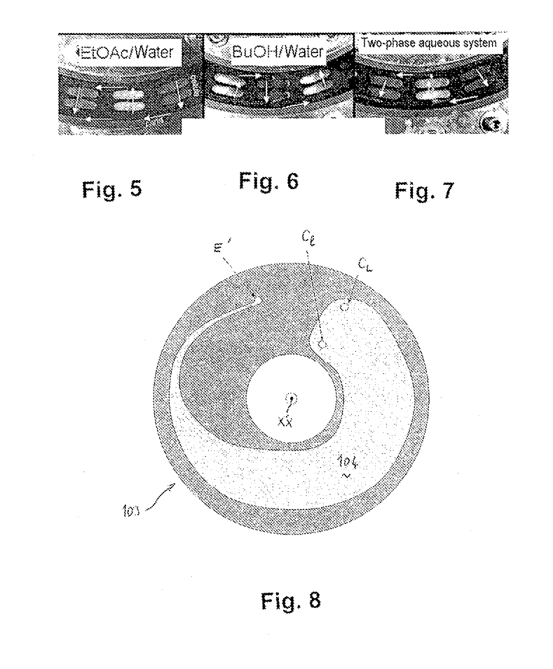

FIG. 6 is a similar photograph showing, as a top view, three cells of a ring according to FIG. 4 being passed through by two liquid phases respectively constituted of butanol and water,

FIG. 7 is a photograph showing, as a top view, three cells of a ring according to FIG. 4 being passed through by two liquid phases respectively constituted of a polyethylene glycol and a potassium phosphate in water, and

FIG. 8 is a schematic top view of a decanter integrated into the device from FIG. 1, according to one exemplary embodiment of the invention.

As illustrated in FIG. 1, a device for contacting phases according to the invention comprises a rotor 1 mounted on a table 2 and capable of being rotated about an axis X′X positioned vertically in the example from FIG. 1, by means of known drive means that are not represented. The rotor 1 is constituted of several flat rings 3 that are stacked, have the same diameter and are firmly attached to a column 4 of known structure formed of a hollow tube positioned between two top 5 and bottom 5′ rotating seals. The axis of rotation X′X corresponds to the axis of the stacked rings 3. The column 4 is fed with fluid phases through the seals 5 and 5′ via a pipe circuit 6 connected to known feed and recovery means that are not illustrated. The rings 3 are placed between two circular flanges 7 and 7′ that have the same outer diameter as that of each ring 3.

Each of the two rotating seals 5 and 5′ may constitute the inlet or the outlet of the device, and the route of the phases in the circuit 6 is shown by a bold line in FIG. 1. More specifically, in the case where the inlet of the device corresponds to the rotating seal 5, a first branch 6a of the circuit 6 connects the feed means (such as a pump) to this rotating seal 5 that communicates with a second branch 6b bringing the phases under pressure to the inlet of the rotor 1 then, in the bottom part of the latter, to the branch 6c. The branch 6d, located inside the column 4, then brings the phases to the lower rotating seal 5′ then to the branch 6e and toward the recovery means.

For all of FIGS. 2 to 7, the term “radial” describes any direction parallel to a radius of a ring 3a, 3, 3′ and the term “tangential” describes any direction perpendicular to a radius of the latter.

The ring 3a not in accordance with the invention which is illustrated in FIG. 2 (the arrows G of which symbolize the centrifugal acceleration field), has, in the vicinity of its outer periphery, a circumferential arrangement of cells 10 which, in this example, each comprise two identical compartments 11 and 12 which are oblong in the tangential direction of the ring 3a and which are juxtaposed in its radial direction by being connected together by a narrow radial fluid bridge 13. Each cell 10 is provided with two inlet/outlet channels 14 and 15 which connect it fluidly to the two adjacent cells 10 (i.e. the preceding cell and the next cell in the flow direction of the phases) and that open into this cell 10 respectively via two inlet/outlet orifices 14a and 15a which are respectively proximal (i.e. radially inner) and distal (i.e. radially outer) with respect to the axis of rotation X′X of the ring 3a.

These orifices 14a and 15a define a crossing of each cell 10 substantially in the radial direction of the ring 3a and they are above all such that two adjacent cells 10 have the proximal orifice 14a of the one which is directly connected to the distal orifice 15a of the other one via the channel 14 or 15. It results therefrom that all the cells 10 of the ring 3a are passed through by the mobile phase in the sole and unique centrifugal direction of the arrows G (i.e. radially toward the outside) or else in the sole and unique centripetal opposite direction (i.e. radially toward the inside), depending on whether this mobile phase arrives from the right or from the left of FIG. 2, respectively.

Contrary to this, each cell 110 of the ring 3 according to the example of the invention illustrated in FIG. 3 has its two inlet/outlet channels 114 and 115 which open therein respectively via its two proximal 114a and distal 115a orifices in order to be passed through radially in such a way that two adjacent cells 110 have their respective proximal orifices 114a or else their respective distal orifices 115a connected directly together. Indeed, it is seen in FIG. 3 that two adjacent cells 110 of this ring 3 are directly connected together by a tangential channel 114, 115 which is, for some pairs of adjacent cells, radially inner 114 and for other pairs, radially outer 115 (whereas the channels 14 and 15 from FIG. 2 comprise radial portions in order to connect the proximal orifice 14a of one cell 10 to the distal orifice 15a of the next).

It results from this arrangement of the channels 114 and 115 with respect to the cells 110 of the ring 3 according to the invention that the phases passing through these cells 110 in one and the same given circumferential direction (from the right to the left in the example from FIG. 3, see the inlet arrow E and outlet arrow S) via the aforementioned flow means such as pumps, cross certain cells D radially toward the outside (i.e. in a centrifugal direction corresponding to a descending flow direction with reference to the gravitational field, hence the letter “D” identifying these cells) and other cells A radially toward the inside (i.e. in a centripetal direction corresponding to an ascending flow direction with reference to the gravitational field, hence the letter “A” identifying these cells). These multiple inversions of the direction in which the cells 110 are passed through result in as many forced inversions of the continuous/discontinuous phases flowing which substantially improve the agitation between phases, it being specified that the heavy phase will percolate in the discontinuous state into the continuous light phase in all the cells D that are passed through in a descending manner and that conversely this light phase will very rapidly become discontinuous in each of the following cells A that are passed through in an ascending manner in order to percolate therein the heavy phase that has become continuous.

In the example of FIG. 3, it has been chosen to make the cells A and D follow one another alternately, via the corresponding alternation of the radially inner 114 and radially outer 115 tangential channels, which has the advantage of forcing these multiple phase inversions to a high frequency (i.e. with a period that is on the contrary very brief), which makes it possible to optimize the intensity of the agitation even more and therefore the efficacy of the desired mass transfer. As indicated previously, as a variant, a quasi-alternation of these cells could be chosen by inserting one or more cells A or D between two consecutive cells A and D, following a repeat pattern for example of AADAADAA or else ADDADDA type, non-limitingly.

Moreover it is seen in FIG. 3 that the cells 110, which are each of the type having two compartments 111 and 112, 111′ and 112′ that are radially juxtaposed and connected via a narrow radial bridge 113 following the example of what was described in FIG. 2, have different tangential compartment widths depending on whether they are D cells that are passed through centrifugally or A cells that are passed through centripetally. Indeed, provision is advantageously made, in the case of a flow rate of heavy phase greater than that of the light phase (for example with a ratio of flow rates of the order of 7/3 between heavy phase and light phase), of a tangential width which is smallest for these A cells and which is largest for these D cells.

The ring 3′ according to the invention illustrated in its entirety in the variant of FIG. 4 differs only from that of FIG. 3 in that its cells 210 having two compartments 211 and 212 connected by a bridge 213 are all identical and therefore analogous to those described above for FIG. 2. This ring 3′ therefore has, following the example of the ring 3, an alternation of A cells that are passed through centripetally in an ascending manner and D cells that are passed through centrifugally in a descending manner, via the aforementioned alternation of the radially inner tangential channels 214 that connect together the proximal cell orifices 214a and radially outer tangential channels 215 that connect together the distal cell orifices 215a, in order to force said multiple phase inversions to a high frequency. As this is also the case for the ring 3 from FIG. 3, it will be noted that the pressure loss in the device according to the invention remains low, due to the fact that the number of cells per ring 3, 3′ is relatively low therein, and above all due to inversions of the direction in which the cells 110, 210 are passed through which lead to a compensation of the hydrostatic pressure in the device.

Generally, it will be noted that the cells 110, 210 of a ring 3, 3′ according to the invention and also the channels 114, 214 and 115, 215 connecting them together may be either etched, or pierced across the ring 3, 3′ (it being possible for the number of cells 110, 210 per ring 3, 3′ to vary from a few to several hundreds). The axial thickness of the cells 110, 210, and also their radial length and their tangential width, may vary to a large extent and with no real upper limit, which may where necessary result in a device of large volume that makes it possible to treat large amounts of fluids. By way of indication, the hollow volume Vc of the column of rings 3, 3′ of a device according to the invention may vary from a few tens of milliliters for analytical applications in particular, to several hundreds of liters for industrial applications. As regards the flow rates used for these fluids, they can be chosen depending on the desired applications and adjusted independently in the device.

The images from FIGS. 5 to 7 illustrate the continuous/discontinuous phase inversions obtained by means of a ring 3′ according to FIG. 4 having a thickness approximately equal to 0.5 cm and comprising 23 cells 110 that follow one another in an alternating manner via 12 D cells that are passed through centrifugally and 11 A cells that are passed through centripetally. This tested ring 3′ allows flow rates of at least 300 ml/min. Tests of agitation between two liquid phases were carried out in the laboratory using this ring 3′, with a total volume occupied by the fluids of approximately 30 ml.

FIG. 5 shows the phase inversions obtained for a two-phase ethyl acetate/water (EtOAc/water) system, FIG. 6 for a two-phase butanol/water (BuOH/water) system and FIG. 7 for a two-phase aqueous polyethylene glycol 1000 (PEG1000) (12.5% weight/weight)/potassium monohydrogen phosphate in water (K₂HPO₄ in a weight/weight ratio of 12.5%) system. The flow rates used varied from 25 to 60 ml/min for each phase, the direction of the flows being that indicated by the arrows.

In these FIGS. 5 to 7, the lightest cells, which correspond to said “ascending” A cells that are passed through in the centripetal direction, show a dispersion by broken jet or “spray” of the relatively dark (blue) light phase in the continuous heavy phase which is virtually colorless. Conversely, the darkest cells, which correspond to said “descending” D cells that are passed through in the centrifugal direction, are those where this virtually colorless heavy phase flows in dispersed form into the blue light phase which is then the continuous phase. The phase inversion has taken place at each passage from an A or D cell to the next D or A cell, and the ratio of the relative volumes of the phases in these cells is inverted during each passage (for example 20/80 then 80/20).

Specifically regarding the third test that relates to the two-phase aqueous PEG1000/K₂HPO₄ system, the total flow rates of the two phases circulating in the ring 3′ were in addition varied to a larger extent, from 0 to 300 ml/min. It should be noted that such a two-phase aqueous system is difficult to decant and that in this ring 3′ according to the invention it has not prevented the inversion of phases from taking place each time the alternating cells A and D are passed through (with an overall flow rate of 300 ml/min, this phase inversion took place every 0.25 seconds, i.e. at an inversion frequency of 4 Hz).

FIG. 8 shows an example of a phase decanter which is integrated into the device according to the invention before its outlet and which is constituted by the last rotating unit 103 of the stack from FIG. 1 also rotatably mounted about the axis X′X, and formed of a disc on which a decantation channel 104 is etched that is substantially circular and has an increasing width, in this exemplary embodiment, between its inlet E′ for the phases to be decanted and, in the opposite direction, its two adjacent collection outlets C₁ for the light phase and C_{L} for the heavy phase. It is possible to collect these phases separately either via a two-way rotating seal, or simply by two outlets, one axial and the other radial.

1. A device for bringing immiscible fluid phases into contact by means of centrifugal force, the device comprising at least one contacting unit which is capable of being rotated about an axis and which comprises a plurality of cells configured to be passed through successively by these phases in one and the same given flow direction, each cell being provided with two inlet/outlet channels which fluidly connect the cells together in pairs and which open into each cell respectively via two inlet/outlet orifices which are respectively proximal and distal with respect to said axis, characterized in that, for at least two adjacent cells of said at least one unit, their two proximal orifices or else their two distal orifices are directly connected together by one of these channels, so that these phases flow through one of these adjacent cells toward said axis and through the other cell away from said axis.

2. The device as claimed in claim 1, wherein said channels subdivide into at least one proximal channel formed between said axis and said two adjacent cells which it connects to one another via their respective proximal orifices and/or into at least one distal channel formed beyond said two adjacent cells with respect to said axis which it connects to one another via their respective distal orifices.

3. The device as claimed in claim 1, wherein said at least one unit comprises a ring which is capable of being rotated about its axis of symmetry forming said axis and on the circumference of which said plurality of cells is formed.

4. The device as claimed in claim 3, wherein said plurality of cells has, repeated multiple times over the circumference of said ring, on the one hand, said two adjacent cells having radially inner proximal orifices that are connected together and, on the other hand, said two adjacent cells having radially outer distal orifices that are connected together, so that these phases flow through the cells radially toward the inside and toward the outside in a predetermined, preferably alternate sequential manner over this circumference.

5. The device as claimed in claim 4, wherein said ring comprises several of said proximal channels and distal channels that are respectively radially inner and outer with respect to said cells that they connect together and that both extend substantially perpendicular to the radial direction of this ring passing through said axis.

6. The device as claimed in claim 3, wherein each of said cells has said two inlet/outlet orifices which are respectively radially inner and radially outer with respect to this cell and which are substantially situated on a radial line of said ring passing through said axis and for example through the barycenter of this cell seen in radial cross section.

7. The device as claimed in claim 3, wherein each of said cells is formed of several compartments which are juxtaposed in the radial direction by being connected together in pairs via a radial fluid bridge.

8. The device as claimed in claim 7, wherein said compartments of one and the same cell, which are identical or different, have an oblong shape in the circumferential direction, said or each radial bridge being substantially aligned with said two inlet/outlet orifices of each cell.

9. The device as claimed in claim 3, wherein the device comprises a multitude of said rings of flat shape which are stacked about said axis and which are configured to form as many stages of mass transfer, via a gravitational field to which said cells are subjected and which matches descending and ascending movements of the phases respectively to their radially outward and inward flow through the cells.

10. The device as claimed in claim 9, wherein the device is provided with means for collecting said phases that are formed:
at the outlet of the device in the form of a separate decanter, or else,
by a disc rotating about said axis that is integrated into the device at the outlet of said unit(s), via a decantation channel formed in this disc in a substantially circular manner along a constant or variable width or else in a spiral.

11. A process for bringing immiscible fluid phases into contact by means of centrifugal force, the process comprising a rotation about an axis of a plurality of contacting cells which are passed through successively by these phases in order to obtain in each cell a continuous phase in which another discontinuous phase is dispersed, characterized in that it comprises a flow in one and the same given direction of the phases from one cell to another cell so that these phases come closer to then move away from said axis when they pass through these cells, in order to obtain an inversion of the continuous phase and of the discontinuous phase at each change of their direction for passing through the or each corresponding cell.

12. The phase-contacting process as claimed in claim 11, wherein one of the phases, or heavy phase, is dispersed in the other phase, or light phase, at the or each phase inversion resulting from them passing through a cell in the direction of moving away from said axis and, conversely, in that the light phase is dispersed in the heavy phase at the or each phase inversion resulting from them passing through a cell in the direction of moving closer to said axis.

13. The phase-contacting process as claimed in claim 11, wherein multiple inversions of these continuous and discontinuous phases are performed in a predetermined and preferably alternate sequential manner at each change of their direction for passing through the cells.

14. The phase-contacting process as claimed in claim 13, wherein said cells are formed in at least one contacting unit that is rotated about its axis of symmetry forming said axis and over the circumference of which said plurality of cells is formed, which cells generate these multiple inversions of continuous and discontinuous phases via the arrangement of inlet/outlet channels connecting these cells together in pairs.

15. The phase-contacting process as claimed in claim 12, wherein said cells have at least two different widths in the circumferential direction, including a minimum cell width and a maximum cell width for the cells passed through by these phases radially inward and outward, respectively, for a flow rate of the heavy phase greater than that of the light phase.

16. The phase-contacting process as claimed in claim 11, wherein these phases are brought into contact via a gravitational field to which said cells are subjected and which matches descending and ascending movements of the phases respectively to them passing through the cells radially outward and inward.

17. The phase-contacting process as claimed in claim 11, wherein an operation is performed via this contacting step, which operation is chosen from the group consisting of liquid-liquid extractions, gas-liquid extractions, solid-liquid-liquid three-phase extractions, chromatographies, chemical reactions in a two-phase medium and the production of nanoemulsions, and in that optionally, in addition, a decantation operation is carried out in order to separate the phases brought into contact in said cells from one another.
